(19) United States
(12) Patent Application Publication
(10) Pub. No.: US 2009/0044228 A1
(43) Pub. Date: Feb. 12, 2009

(54) METHOD FOR PROVIDING INFORMATION RELATED TO AVAILABLE BROADCAST PROGRAMS IN A MOBILE COMMUNICATION NETWORK

(75) Inventors: Carine Balageas, Gif Sur Yvette (FR); Alberto Conte, Cachan (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 12/186,635

(22) Filed: Aug. 6, 2008

(30) Foreign Application Priority Data
Aug. 10, 2007 (EP) 07291003.7

(51) Int. Cl. G06F 3/00

(52) U.S. Cl. 725/48

(57) ABSTRACT

Disclosed is a method for providing information related to available broadcast programs, such as Electronic Program Guides or parts thereof, in a mobile communication network comprising a plurality of cells, with respective base stations. The cells with their base stations are part of a broadcast zone managed by a server. The server identifies the available broadcast programs and transmits the information via the base stations to access terminals that are serviced by those base stations. The base stations establish a specific EPG broadcast connection and transmit the information to the access terminals being serviced by them, over the specific EPG broadcast connection.

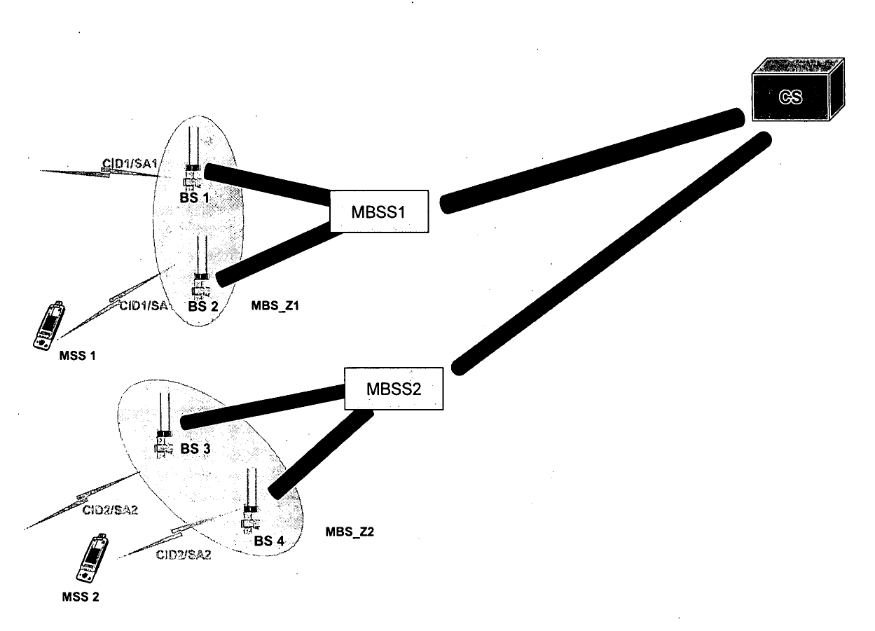

The subject invention relates to a method for providing information related to available broadcast programs in a mobile communication network as described in the characteristic part of claim 1.

Such a method is described in the US patent Application US 2005/0249142 A1. Therein a method is disclosed for providing a broadcast service in a mobile communication system including a plurality of cells being part of a broadcast zone such as defined in the WiMax IEEE 802.16e standard. The described method includes the transmission of broadcast program information related to available broadcast programs in the broadcast zone using a MAP message. This broadcast program information is zone specific and is limited to identifiers that are mapped to respective programs.

The MAP message is not suited for providing more extensive information such as f.i. on the content of the programs or on schedules as in electronic program guides. Also, none of the current standards related to wireless broadcasting foresee the possibility to efficiently transmitting to a user the amount of information provided in an electronic program guide.

It is an object of the subject invention, to provide a method that supports provision of electronic program guides, hereafter called EPGs, in a wireless broadcast environment in an efficient way.

This objective is realized by means of the features of the characterizing part of claim 1. Indeed, thanks to the established fixed EPG broadcast connection set up by the base stations any access terminal entering the broadcast zone can over this connection receive at least part of the extensive EPG information.

According to the characteristic features of claims 2 and 3 this connection can be established in two ways: the connection can have the same connection identity known by the access terminals for all base stations of all the zones and be permanently established or it can be a fixed connection set up by each base station with the same connection identifier for all base stations of a zone that are mapped to a fixed EPG Multicast IP address preconfigured in the access terminals.

The subject invention foresees two scenario's for providing the EPG to the access terminals. In a first one the whole EPG and subsequent updates on the EPG are sent to the access terminals over the broadcast connection, in a second one an initial complete EPG is sent over a unicast connection, and subsequent updates are sent over the fixed EPG broadcast connection in accordance with claim 4. Sending updates instead of a complete EPG reduces the bandwidth needed for broadcasting the EPG.

In the first scenario the access terminal can enter the broadcast zone at the moment updates are being broadcasted. This means that the access terminal will have to wait for some time before it gets a first complete EPG.

This is not the case in the second scenario where, as soon as the access terminal enters the broadcast zone, the unicast connection is established by the servicing base station managed by the server and the EPG is transmitted to the access terminal.

The invention also relates to a server, a base station and an access terminal realizing the subject method as claimed in claims 7 to 13.

The above and other aspects of the invention will become more apparent and the invention will be better understood from the following description when read in conjunction with the accompanying figure that shows an architecture realizing the above introduced method.

The system shown in this figure is a multi-base station, further called Multi-BS, access mode wireless communication system according to the WiMax IEEE 802.16e standard.

It includes a content server CS connected to two Multicast and Broadcast Service Servers MBSS1 and MBSS2 who manage a multicast and broadcast service zone being MBS_Z1 and MBS_Z2 respectively. BS1 and BS2 are two base stations in MBS_Z1, and base stations BS3 and BS4 are located in MBS_Z2. The figure also shows two mobile stations MS1 and MS2 in zone MBS_Z1 and MBS_Z2 respectively.

As explained and defined in 802.16, in Multi-BS access mode a specific Multicast and Broadcast Service (MBS) service flow is transmitted over several Base Stations (BSs) by using the same Connection Identifier (CID) and same Security Association (SA). A set of such BSs form the MBS Zone identified by a unique MBS_Zone_id broadcast by each BS.

The content server CS of the considered system provides to the MBS Servers MBSS1 and MBSS2 information on the content that can be provided to their respective MBS zones. This information contains a bouquet of channels such as national TV channels and more specific sport channels or local channels, available in the broadcast zones and their EPG. Using this information the MBS servers can build up a global electronic program guide (EPG) applicable their respective broadcast zone. Such a program guide includes f.i. information on the available content and on the timing of their availability.

The content server can in different alternative embodiments periodically provide new EPGs or updates on an initially provided complete EPG.

In the considered system there is only one content server, but the MBS server can in an alternative implementation also be connected to several content providers in which case it will aggregate the information from those different providers to provide an aggregated EPG.

The MBS servers manage the base stations of their zone as described in IEEE 802.16. Using this standardized protocol MBSS1 and MBSS2 instruct BS1 and BS2, and BS3 and BS4 respectively to set up a permanent EPG broadcast connection with a connection identifier CID1 and Security Association SA1 dedicated to the transmission of the EPG. How such connections are set up is also described in IEEE 802.16. This connection is created at network entry or zone entry of the access terminal by the base stations using the classical Dynamic Service addition procedure as described in 802.16e.

The EPG or updates thereof are then forwarded to the base stations for transmission over the EPG broadcast connection.

In possible alternative scenarios, the content provider provides complete EPGs. In this case, the MBS servers send complete EPG or in an alternative implementation they can periodically buffer a complete EPG and compute the difference with a subsequently received EPG and send only these differences to the base stations.

MSS1 and MSS2 are preconfigured with CID1. Upon entering a broadcast zone, they start “listening” to the connection identified by CID1 being the EPG broadcast connection and in this way obtain the EPG or updates thereof.

In an alternative implementation, instead of having a fixed connection identity for all base stations, a generic EPG multicast IP address is precoded in all mobile stations. The servicing base station then maps this IP address to a connection identifier and security association of an EPG broadcast connection set up by this base station and inform the access terminal thereof. From then on the access terminal can listen to this connection for receiving the EPG and EPG updates.

This method of providing EPG information to access terminals implies that if a base station is sending out EPG updates when an access terminal is starting to be serviced by this base station, the terminal has to wait for some time before getting a new complete EPG. This can be cumbersome for a user of the access terminal if that waiting time is experienced as being too long.

To avoid this situation an alternative implementation relies on the establishment of a unicast connection by a servicing base station to an access terminal entering the broadcast zone. An initial complete EPG is then sent to the access terminal over this unicast connection. Further updates are subsequently sent via a broadcast connection in accordance with the method described before. Each time a new complete EPG is sent out this is done via a unicast connection.

The MBS servers interact with a Service Flow Authorization module as described in the WiMax Forum Network Architecture—Stage 3—Detailed Protocols and Procedures—Release 1.0.0 standard. This module is responsible for evaluating any service request against a user Quality of Service profile. This user Quality of Service profile obtained by the Service Flow Authorization module from an Authentication, Authorization and Accounting module, again according to WiMax Forum, upon network entry by the mobile station. The Quality of Service Profile includes amongst other information, the list of pre-provisioned service flows that have to be created immediately at network entry. One of these services is the unicast service flow for the whole EPG and the broadcast service flow for the updates.

The detailed implementation of the elements of the above described systems for the different scenarios and with respect to the different alternatives is not described herein in details because it is obvious for a person skilled in the art based on the given functional description and on the content of the IEEE 802.16e standard how to realize this.

While the principles of the invention have been set out above in connection with specific embodiments and relating to a specific standard, it is to be clearly understood that this description is merely made by way of example and not as limitation of the scope of protection which is determined by the appended claims.

1. Method for providing information related to available broadcast programs in a mobile communication network comprising a plurality of cells, with respective base stations, that are part of a broadcast zone, said broadcast zone being managed by a server, and wherein said method includes the steps of:
said server identifying said available broadcast programs and
said server transmitting said information via said respective base stations to access terminals being serviced by said respective base stations,
characterized in that said information consists of at least part of an electronic program guide and that said method includes the additional steps of:
said respective base stations establishing a specific EPG broadcast connection and
said respective base stations transmitting said information to those of said access terminals that they are servicing over said specific EPG broadcast connection

2. Method according to claim 1, characterized in that said specific EPG broadcast connection has a same fixed connection identity for all said respective base stations, that said same fixed connection identity is preconfigured in said access terminals and that said access terminals upon entry in said broadcast zone listen to a broadcast connection with said fixed connection identity to receive said information.

3. Method according to claim 1 characterized in that a fixed EPG Multicast IP address is preconfigured in said access terminals and that said fixed EPG Multicast IP Address is mapped to a connection identity identifying said specific EPG broadcast connection by those of said specific base stations servicing said access terminal.

4. Method according to claim 1 characterized in that said information consists of updates of said electronic program guide and that said method includes the additional step of sending a complete electronic program guide to said access terminals upon entry in said broadcast zone over a unicast connection established by those of said respective base stations servicing said access electronic program upon said entry.

5. Method according to claim 1, characterized in that said wireless communication network supports an Institute of Electronical and Electronics Engineering 802.16 standard.

6. Method according to claim 5, characterized in that said connection identity consist of a connection identifier and a security association value.

7. Server adapted to manage base stations associated with corresponding cells forming a broadcast zone in a wireless communications network, characterized in that said server is adapted to build up an electronic program guide of content available in said zone from information received from at least one content provider and to send said electronic program guide to said base stations, said server also being adapted to manage said base station to set up a specific EPG broadcast connection to transmit at least part of said electronic program guide to access terminals being serviced by respective ones of said base stations.

8. Server according to claim 7, characterized in that said at least part of said electronic program guide consists of updates of an initial complete electronic program guide and that said server is adapted to manage said base stations to establish a unicast connection with said access terminals to transfer said initial complete electronic program guide to said access terminals.

9. Base station associated with a cell that is part of a broadcast zone in a wireless communications network, characterized in that said base station is adapted to receive from a server managing said base station at least part of an electronic program guide related to content available in said zone, said base station also being adapted to set up a specific EPG broadcast connection for access terminals entering said zone and to transmit said at least part of said electronic program guide to said access terminals via said specific EPG broadcast connection.

10. Base station according to claim 10, characterized in that at least part of said electronic program guide consists of updates of an initial complete electronic program guide and that said base station is adapted to establish a unicast connection those of said access terminals it is servicing and to send said initial complete electronic program guide to those over said unicast connection.

11. Access terminal adapted to receive from a base station associated with a cell that is part of a broadcast zone in a wireless communication network at least part of an electronic program guide over a specific broadcast connection having a fixed connection identity, said connection identity being preconfigured in said access terminal.

12. Access terminal adapted to receive from a base station associated with a cell that is part of a broadcast zone in a wireless communication network at least part of an electronic program guide over a specific broadcast connection having a fixed connection identity being provided by said base station after having apped it to a fixed EPG broadcast IP address preconfigured in said access terminal.

13. Access terminal according to claim 11 characterized in that said at least part of said electronic program guide consists of an update of an initial complete program guide, said access terminal being adapted to receive said initial complete program guide over a unicast connection set up by said base station.
